(19) United States
(12) Patent Application Publication
(10) Pub. No.: US 2007/0274531 A1
(43) Pub. Date: Nov. 29, 2007

(54) Sound pressure monitor

(75) Inventor: William O. Camp, Chapel Hill, NC (US)

Correspondence Address: COATS & BENNETT/SONY ERICSSON, 1400 CRESCENT GREEN, SUITE 300, CARY, NC, 27511, US

(73) Assignee: Sony Ericsson Mobile Communications AB

(21) Appl. No.: 11/440,273

(22) Filed: May 24, 2006

(51) Int. Cl. H04R 1/10; H04R 3/00

(52) U.S. Cl. 381/74; 381/95; 381/321

(57) ABSTRACT

A method and apparatus for automatically adjusting the volume of a headset is described herein. The headset includes a speaker and a pressure transducer. The speaker projects audible signals into the ear canal, while the pressure transducer measures a sound pressure level in the ear canal. Based on the measured sound pressure level, a control system controls the volume of the audible sound projected from the speaker.

### BACKGROUND

The present invention generally relates to headset volume control, and more specifically relates to automatic volume control for earbud headsets.

Headsets provide a convenient audio interface for a variety of electronic devices, including cellular telephones, portable music players, portable multi-media players, etc. Of particular interest to consumers are high performance headsets that are small, lightweight, and reliable. Earbud headsets represent one type of headset that meets all of these requirements.

In some instances, it may be desirable to maintain the volume of the sound projected into the ear below some maximum level. However, even when a user sets the volume, the perceived and/or actual volume of the projected sound may change dramatically over time due to changing environmental noise levels, changing audio file amplitudes, etc. To maintain the projected sound at the desired volume, the user must repeatedly manually adjust the volume as various conditions change. Often manual volume adjustment may be cumbersome and/or inconvenient. Therefore, there remains a need for improved volume control for headsets.

### SUMMARY

The present invention provides a method and apparatus to automatically adjust the volume of a headset. The headset includes a speaker that projects audible signals into the ear canal. A sound pressure transducer measures a sound pressure level in the ear canal. Based on the measured sound pressure level, a control system controls the volume of the headset. According to one exemplary embodiment, the control system reduces the volume when the measured sound pressure level exceeds a predetermined threshold.

### BRIEF DESCRIPTION OF THE DRAWINGS

FIG. 1 shows a cross section of a portion of the human ear.

FIG. 2 shows a block diagram of a closed-loop volume control system according to one exemplary embodiment.

FIG. 3 shows one exemplary volume control procedure according to the present invention.

FIG. 4 shows another exemplary volume control procedure according to the present invention.

FIG. 5 shows a block diagram of a DSP according to one exemplary embodiment of the present invention.

FIG. 6 shows a block diagram of parts of the closed-loop volume control system of FIG. 2 and the DSP of FIG. 5 for multiple-frequency band operation.

### DETAILED DESCRIPTION

The following describes a closed-loop volume control system for earbud headsets that automatically controls a volume of audible signals projected by an earbud into the ear canal based on a sound pressure level measured in the ear canal. To better understand the present invention, the following first describes the basic operation of the ear and how earbud headphones function within the ear canal.

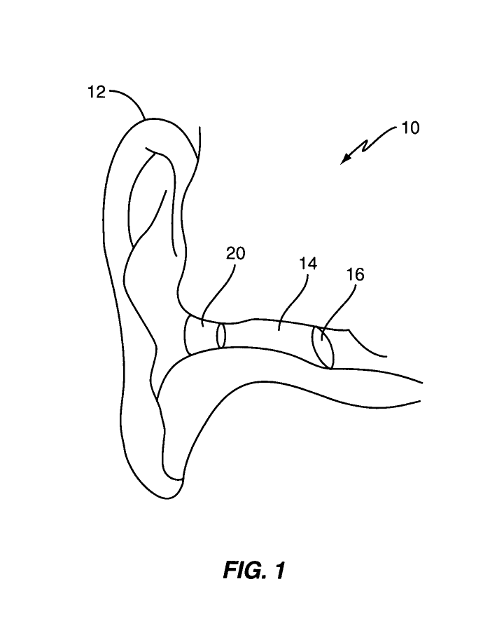

FIG. 1 illustrates a partial cross-section of a human ear 10. Ear 10 includes pinna 12, outer ear canal 14, and ear drum 16. Typically, pinna 12 collects pressure deviations from the environment, while outer ear canal 14 channels the collected pressure deviations to the ear drum 16, causing the ear drum 16 to vibrate. Various anatomical structures (not shown) behind ear drum 16 detect the vibrations, form nerve impulses based on the detected vibrations, and send the nerve impulses to the brain. The brain interprets the received nerve impulses as sound.

FIG. 1 also shows a conventional earbud 20 positioned within the outer ear canal 14. When positioned in outer ear canal 14, earbud 20 at least partially seals off the outer ear canal 14. As a result, ear canal 14 channels most of the audible signals projected by earbud 20 directly to ear drum 16. This feature typically provides superior sound quality relative to other conventional headphones. However, this feature also produces higher pressure deviations, referred to herein as sound pressure levels (SPLs), in the ear canal 14 when compared to other non-earbud headphones operating at the same volume. These elevated pressure deviations may damage the ear.

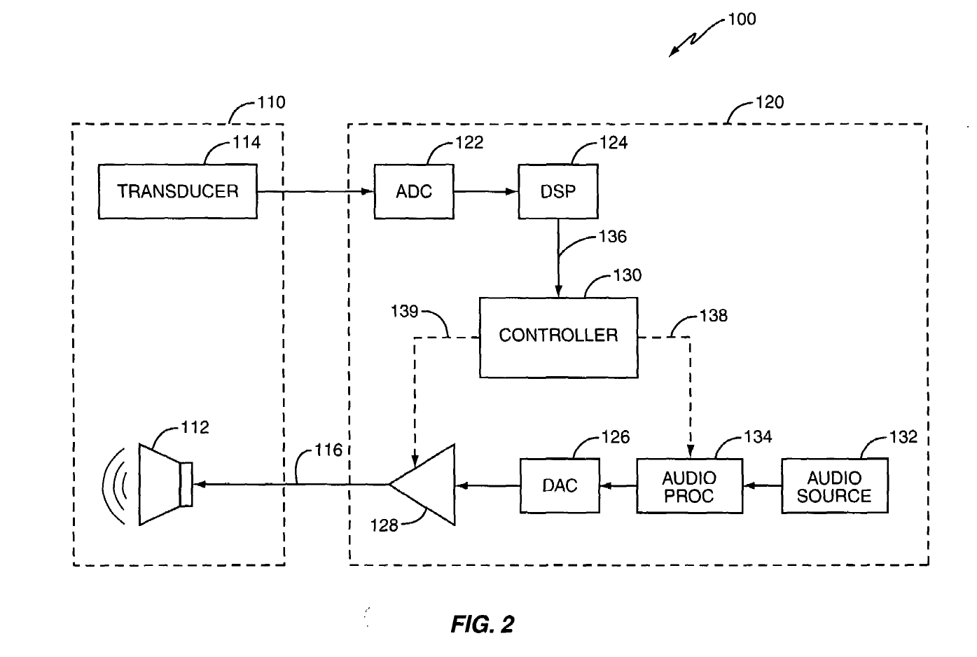

The present invention automatically controls the SPL in the ear canal 14 by measuring a current SPL in the ear canal 14 and adjusting the volume of projected audible signals based on the measured SPL. FIG. 2 shows a block diagram of a closed-loop volume control system 100 according to one exemplary embodiment. Closed-loop control system 100 includes one or more earbuds 110 connected to a remote electronic device 120. While FIG. 2 illustrates the interface between earbud 110 and electronic device 120 as a wired interface, the present invention may also be implemented with a wireless interface between earbud 110 and device 120.

Each earbud 110 includes speaker 112 and pressure transducer 114. Speaker 112 may comprise any speaker conventionally used in earbud headsets, while transducer 114 may comprise any transducer configured to accurately detect sound pressure deviations. When earbud 110 is disposed in an ear canal 14, speaker 112 projects audible signals into ear canal 14, causing pressure deviations in the ear canal 14. Transducer 114 senses these pressure deviations, and converts the sensed pressure deviations to an electrical signal representative of the SPL in the ear canal 14. As used herein, SPL refers to an analog or digital electrical signal used in an electronic system or computer program that is representative of the physical SPL present in ear canal 14. The measured SPL may be the result of the projected audible signal from speaker 112, external environmental noise coupled to ear canal 14, or any combination thereof. According to one exemplary embodiment, transducer 114 and speaker 112 are acoustically coupled to each other in the outer ear canal 14 and acoustically isolated from each other in earbud 110 to ensure that the measured SPL corresponds to the SPL in the ear canal 14.

Remote electronic device 120 receives the measured SPL from transducer 114 and drives speaker 112 with a volume controlled audio signal 116 generated based on the measured SPL. To that end, remote electronic device 120 includes analog-to-digital converter (ADC) 122, digital signal processor (DSP) 124, digital-to-analog converter (DAC) 126, amplifier 128, controller 130, audio source 132, and audio processor 134. ADC 122 converts the analog SPL provided by transducer 114 to a digital SPL. DSP 124 processes the digital SPL to generate a volume control signal 136, as discussed further below. DAC 126 converts digital audio signals from an audio source 132 to analog audio signals. Audio source 132 may comprise any known source of audio files, including a memory configured to store audio files, a radio transceiver configured to receive audio broadcasts, etc. An audio processor 134 may process the retrieved audio signals by, for example, formatting the data from audio source 132 into a form suitable for DAC 126. Amplifier 128 amplifies the analog audio signals to generate the speaker drive signal 116 input to speaker 112 in earbud 110. The amplifier 128 may comprise one or more amplifier circuits, including one or more variable gain amplifiers, that amplify the analog audio signals according to any known means. Controller 130, in addition to generally controlling the operation of electronic device 120, adjusts the volume of audio signals retrieved from audio source 132 and projected from speaker 112 based on the volume control signal 136, as discussed further below.

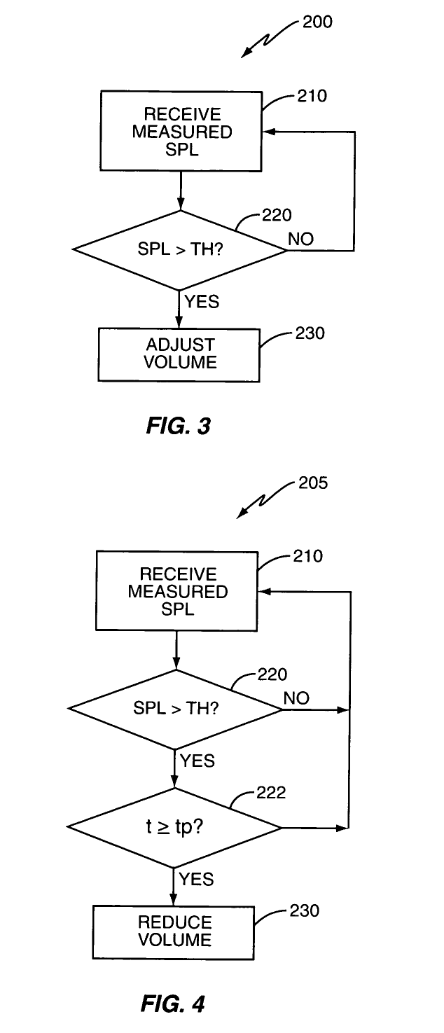

As briefly discussed above, DSP 124 generates a volume control signal 136 based on an analysis of the measured SPL. In one exemplary embodiment, DSP 124 uses a threshold detection process to analyze the measured SPL. FIG. 3 illustrates one exemplary threshold detection process 200 that may be implemented by DSP 124. After receiving a measured SPL (block 210), DSP 124 detects a peak or RMS value of the measured SPL and compares the detected SPL value to a predetermined threshold (block 220). The predetermined threshold may represent any desired SPL limit, and may be set by a manufacturer or user of the electronic device 120. Based on the comparison between the SPL value and the threshold, DSP 124 generates volume control signal 136 to adjust the volume of the projected audible signals (block 230). While not explicitly shown, DSP 124 may include a detector and a comparator to implement the threshold detection process.

FIG. 4 illustrates another exemplary threshold detection process 205 that may be implemented by DSP 124. After receiving a measured SPL (block 210), DSP 124 detects a peak or RMS value of the measured SPL and compares the detected SPL value to a predetermined threshold (block 220). If the detected SPL value exceeds the threshold (block 220) for more than a predetermined length of time (block 222), DSP 124 generates a control signal 136 (block 230) to reduce the volume. For example, if the detected SPL exceeds 100 dBA for more than 60 minutes or exceeds 65 dBA for more than 40 hours in one week, control signal 136 directs controller 130 to reduce the volume, and therefore, to reduce the SPL in the ear canal 14 to an acceptable level. Otherwise, DSP 124 continues to monitor the SPL relative to the predetermined threshold and time limit (blocks 210, 220, 222). It will be appreciated that the present invention is not limited to the single threshold and time limit of the above examples. In alternative embodiments, DSP 124 may track multiple time intervals relative to multiple different SPL thresholds. For example, a first timer may track how long the detected SPL exceeds a first threshold, such as 75 dB, while second and third timers may track how long the detected SPL exceeds second and third thresholds, respectively. Based on these thresholds and the pre-determined time limits associated with each timer, DSP generates a volume control signal 136 that controls the volume of the projected audible signals.

Controller 130 controls the volume of the projected audible signals by controlling the volume of the audio signals retrieved from audio source 132 based on the volume control signal 136 generated by DSP 124. In one embodiment, controller 130 controls the volume by adjusting the amplitude of the projected audible signals. For example, controller 130 may generate a digital control signal 138 based on the volume control signal 136. Audio processor 134 then applies digital control signal 138 to the retrieved audio signals to reduce the amplitude of the retrieved audio signals input to DAC 126, and therefore, to reduce the amplitude of the projected audible signals. Audio processor 134 may, for example, apply the digital control signal 138 to the retrieved audio signals by digitally multiplying the retrieved audio signals by an appropriate digital scaling factor identified by digital control signal 138. This scaling factor may scale the amplitude of all audio signals by the same amount. Alternatively, the scaling factor may help control distortion by only scaling the amplitude of selected audio signals, such as those that exceed some predetermined threshold. In either case, the scaled audio signals are then applied to DAC 126 and subsequently to amplifier 128. Based on the drive signal 116 provided by amplifier 128, speaker 112 projects audible signals at a desired volume.

In another embodiment, controller 130 may generate an analog control signal 139 that controls the amplitude of the projected audible signals by controlling the gain of amplifier 128. For example, based on volume control signal 136, controller 130 may generate an analog control signal 139 that reduces the gain of amplifier 128, and therefore, decreases the amplitude of the projected audible signals. It will be appreciated that analog control signal 139 may universally control the amplifier gain for all input audio signals or may alternatively only control the gain of selected input audio signals, such as those exceeding some predetermined threshold. In any event, based on the drive signal 116 provided by amplifier 128, speaker 112 projects audible signals at a desired volume.

In still another embodiment, controller 130 controls the amplitude of projected audio signals by applying the digital control signal 138 to audio processor 134 and analog control signal 139 to amplifier 127 to adjust both the amplitude of the retrieved audio signal and the amplifier gain, respectively. Regardless, volume control signal 136 controls the amplitude of the projected audible signal, and therefore controls the volume of the projected audible signal, by controlling the amplitude of the speaker drive signal 116 output by amplifier 128.

Controller 130 adjusts the volume of the projected audible signals by some predetermined or calculated adjustment value. In one embodiment, the volume control signal 136 may direct controller 130 to incrementally adjust the volume by a predetermined increment until a desired SPL value is detected. For example, if the detected SPL value exceeds a 90 dBA threshold, volume control signal 136 may direct controller 130 to incrementally reduce the volume in 0.5 dB increments until the detected SPL value is below 85 dBA. Alternatively, controller 130 may compute an adjustment value based on the volume control signal 136 and adjust the volume by an amount equal to the computed adjustment value. For example, if the detected SPL value exceeds a 115 dBA threshold, controller 130 computes an adjustment value, i.e., 15 dB, based on the volume control signal 136, and reduces the volume by the computed adjustment value to drop the detected SPL value below 100 dBA.

DSP 124 may be programmed to keep the volume within a desired range over various time periods based on one or more SPL thresholds. To that end, DSP 124 may integrate the measured SPL over one or more defined intervals to determine an SPL exposure. For example, if the detected SPL value exceeds 100 dBA for more than 60 minutes, controller 130 reduces the volume of the projected audible signals to reduce the SPL in the ear canal 14. If the detected SPL value then remains below, for example, 60 dBA for 30 minutes, controller 130 allows the volume to be increased. As discussed above, DSP 124 may track multiple time intervals relative to multiple different SPL thresholds. As a result, the present invention may use multiple thresholds and/or multiple time periods to keep the volume of the projected audible signals within a desired range.

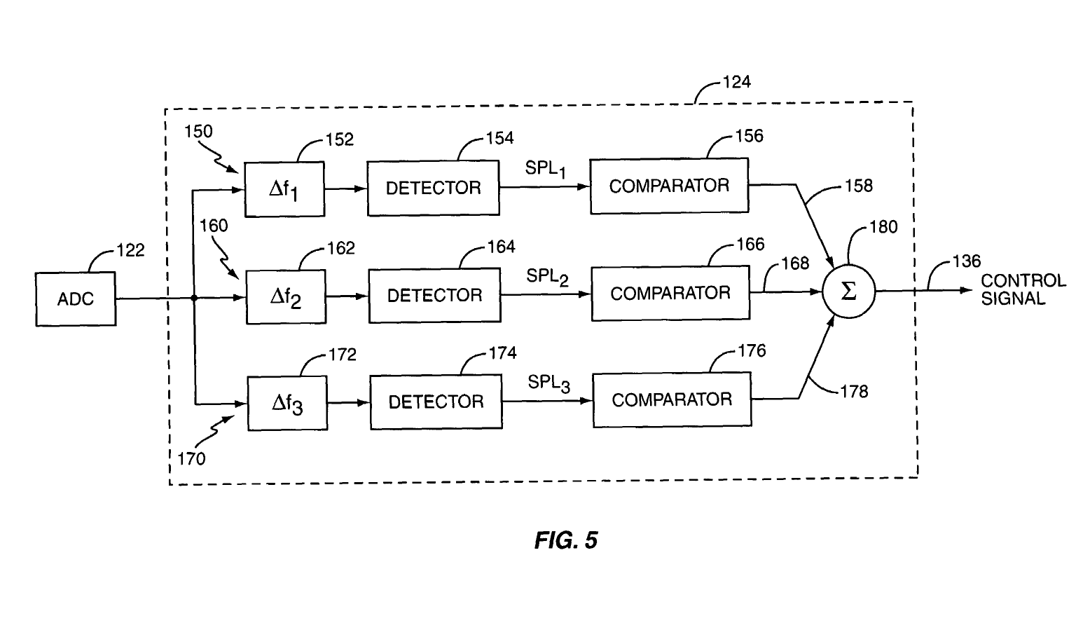

The DSP 124 and controller 130 described above generally apply the same SPL analysis requirements and volume control steps, respectively, to all frequencies of the measured SPL and retrieved audio signal, respectively. However, the present invention may alternatively apply frequency dependent volume control steps to separately adjust frequency components of the retrieved audio signal. FIG. 5 illustrates one exemplary DSP 124 that includes different analysis paths 150, 160, 170 for different frequency bands. In the illustrated example, each analysis path 150, 160, 170 includes a filter 152, 162, 172, a peak/RMS detector 154, 164, 174, and a comparator 156, 166, 176. Each filter 152, 162, 172 isolates frequency components of the measured SPL in different frequency bands, while each detector 154, 164, 174 detects a peak or RMS value of the frequency band-specific SPLs. Each comparator 156, 166, 176 then compares the detected SPL value from the different frequency bands to a threshold. Based on the comparison, each comparator 156, 166, 176 generates a frequency-specific volume control signal 158, 168, 178. Combiner 180 combines the frequency-specific volume control signals 158, 168, 178 into the single volume control signal 136 supplied to controller 130. Controller 130 uses the resulting volume control signal 136 to individually control the volume of different frequency bands of the retrieved audio signals via digital control signal 138 and/or analog control signal 139 as discussed above. Not only does such frequency-specific volume control provide a way to control the SPL in the ear canal 14, but it also provides a way to reduce and/or control frequency-specific distortion in the projected audible signal.

For example, path 150 may analyze low-band frequencies in a 0.1-0.5 kHz band, while paths 160, 170 may analyze mid-band and high-band frequencies in a 0.5-2.5 kHz band and a 2.5-10 kHz band, respectively. To that end, filter 152 passes the measured SPL corresponding to frequencies in the low band, filter 162 passes the measured SPL corresponding to frequencies in the mid band, and filter 172 passes the measured SPL corresponding to frequencies in the high band. Detectors 154, 164, 174 detect the peak or RMS value of the frequency band-specific SPLs. Comparators 156, 166, 176 compare the detected SPL values to predetermined thresholds to generate frequency-specific volume control signals 158, 168, 178. Combiner 180 combines the frequency-specific volume control signals 158, 168, 178 to generate the combined volume control signal 136. Controller 130 uses combined control signal 136 to control the volume of the different frequency bands of the retrieved audio signal. For example, DSP 124 may generate a “reduce” volume control signal 136 for the high frequency band, but not for the low or mid frequency bands. In this example, the combined volume control signal 136 directs controller 130 to only reduce the volume of the high-band frequencies in the retrieved audio signal. In another embodiment, the combined volume control signal 136 may direct controller 130 to adjust different frequency bands of the audio signals by different amounts. It will be appreciated that the present invention is not limited to these examples.

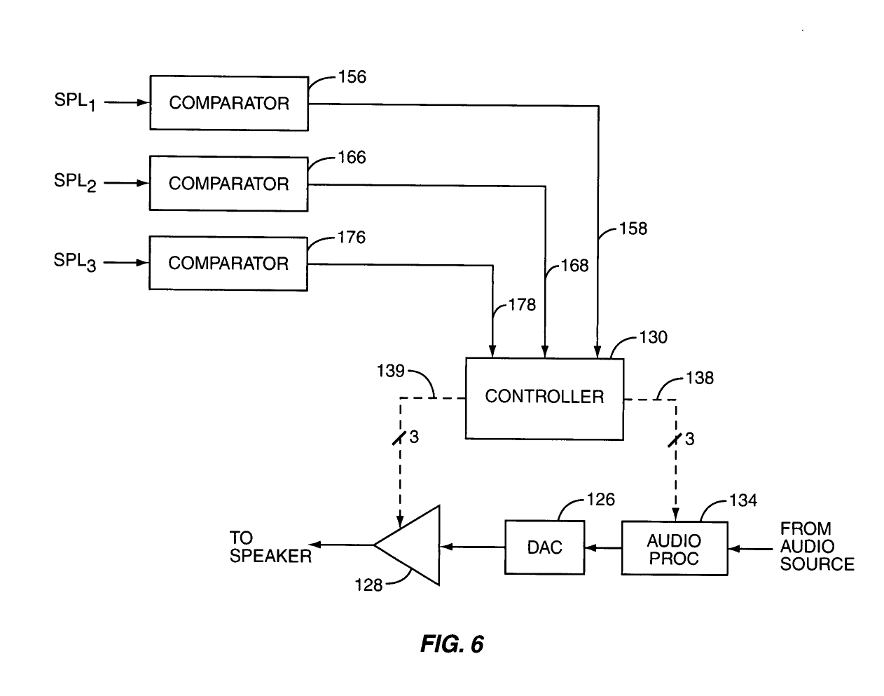

DSP 124 is not limited to the frequency-specific embodiment illustrated in FIG. 5. In an alternative embodiment, DSP 124 may directly provide the individual frequency-specific volume control signals 158, 168, 178 to controller 130. For this embodiment, DSP 124 eliminates combiner 180 and replaces the single volume control signal 136 with the frequency-specific volume control signal 158, 168, 178, as shown in FIG. 6. For simplicity, FIG. 6 only illustrates the relevant parts of electronic device 120 and DSP 124. Responsive to the three frequency-specific volume control signals 158, 168, 178, controller 130 provides three digital control signals 138 to audio processor 134 and/or three analog control signals 139 to amplifier 128 to control the volume of the projected audible signals as discussed above. It will be appreciated that each digital and/or analog control signal 138, 139 controls the amplitude of the audio signals in different frequency bands. For example, audio processor 134 may separate the input audio signals into three different frequency bands and controls the amplitude of these frequency-specific signals by applying frequency-specific scaling factors associated with the digital control signals 138 to the corresponding audio signals. Alternatively, audio processor 134 may pass the retrieved audio signal to amplifier 128 via DAC 126. The amplifier 128 separates the input audio signal into three different frequency bands using appropriate bandpass filters. Amplifier 128 then modifies the gain applied to the frequency-specific audio signals based on the frequency-specific analog control signals 139 supplied by controller 130. In either case, controller 130 individually controls the volume of different frequency components of the projected audible signal.

The above-described frequency dependent analysis and volume control may be used to additionally or alternatively equalize audible signals projected from speaker 112. For example, based on the analyses of the different frequency bands of the measured SPL, controller 130 in combination with DSP 124 may control the volume of different frequency bands of the audio signals to equalize the audible signal projected by speaker 112 as appropriate for the acoustics inside a particular outer ear canal 14. Such equalization may be performed periodically, responsive to user command, or any combination thereof.

It will be appreciated that the above-described frequency-dependent processes are not limited to the three frequency paths 150, 160, 170 shown in FIGS. 5 and 6 or to the three frequency bands discussed above. Further, it will be appreciated that each comparator 156, 166, 176 in the different paths 150, 160, 170 may use different thresholds. Alternatively, one or more comparators 156, 166, 176 may use the same threshold.

The present invention may also be used to suppress or otherwise reduce noise levels inside the ear canal. According to one exemplary embodiment, DSP 124 may analyze an “inactivity” SPL measured by transducer 114 during times when speaker 112 is inactive. This analysis may be frequency dependent or frequency independent. Based in this analysis, DSP 124 and/or controller 130 may generate a noise suppression signal that causes speaker 112 to project an “anti-noise” signal according to any known procedure. Speaker 112 may project the “anti-noise” signal separately and/or jointly with any projected audible signals. Projecting the “anti-noise” signal into the ear canal 14 cancels or reduces the noise present in the ear canal 14, enabling the user to better hear the projected audible signals. The projected “anti-noise” signal also enables the user to hear the projected audible sound at lower volumes than would be required if the noise were present. As such, the noise cancellation process may be combined with the volume control process to reduce the overall SPL inside ear canal 14.

The above-described DSP 124 and controller 130 may be comprised of one or more processors, hardware, firmware, or a combination thereof. While the above describes the DSP 124, controller 130, and audio processor 134 as separate devices in remote electronic device 120, it will be appreciated that all or part of DSP 124 may be co-located with controller 130. Further, it will be appreciated that ADC 122, DSP 124, and/or parts of controller 130 may be co-located with speaker 112 and transducer 114 in earbud 110.

The invention described herein has many benefits over conventional volume control systems. First, by using a closed-loop volume control system to automatically control the volume of audible signals projected from a speaker of an earbud, the present invention enables the user to listen to music or other audible content at a relatively consistent volume regardless of the external environment or amplitude of the retrieved audio signal. Further, parents or other users may use the automatic volume control described herein to set a maximum volume for a portable electronic device. Because the volume control process described above also may be used to set the volume of different frequency components of a projected audible signal at different levels, the present invention also provides automatic equalization of the projected audible signals. This automatic equalization tailors the frequency envelope of the projected audible signals to the acoustics of a particular user's ear.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A closed-loop volume control system for an audio earphone comprising:
a speaker configured to project an audible signal into an ear canal;
a pressure transducer configured to measure a sound pressure level in the ear canal; and
a control system associated with the speaker and the pressure transducer, said control system configured to control a volume of the projected audible signal based on the measured sound pressure level.

2. The closed-loop volume control system of claim 1 further comprising an amplifier configured to drive the speaker responsive to an amplifier drive signal.

3. The closed-loop volume control system of claim 2 wherein the control system controls the volume of the projected audible signal by controlling a gain of the amplifier based on the measured sound pressure level.

4. The closed-loop volume control system of claim 2 wherein the control system controls the volume of the projected audible signal by controlling an amplitude of the amplifier drive signal input to the amplifier based on the measured sound pressure level.

5. The closed-loop volume control system of claim 2 wherein the amplifier comprises a variable gain amplifier.

6. The closed-loop volume control system of claim 1 wherein the control system is configured to reduce a volume of the projected audible signal when the measured sound pressure level exceeds a first threshold.

7. The closed-loop volume control system of claim 1 wherein the control system is configured to reduce a volume of the projected audible signal when the measured sound pressure level exceeds a first threshold for longer than a first time period.

8. The closed-loop volume control system of claim 7 wherein the control system is configured to increase the volume of the projected audible signal when the measured sound pressure level remains below a second threshold for longer than a second time period.

9. The closed-loop volume control system of claim 1 wherein the control system is configured to reduce a volume of the projected audible signal when the measured sound pressure level exceeds a first threshold for longer than a first time period or when the measured sound pressure level exceeds a second threshold for longer than a second time period.

10. The closed-loop volume control system of claim 1 wherein control system is further configured to isolate different frequency components of the measured sound pressure level to generate frequency-dependent sound pressure level measurements.

11. The closed-loop volume control system of claim 10 wherein the control system is further configured to equalize the projected audible signal based on the frequency-dependent sound pressure level measurements.

12. The closed-loop volume control system of claim 10 wherein the control system controls a volume of the projected audible signal by controlling an amplitude of one or more of the frequency components of the projected audible signal based on the frequency-dependent sound pressure level measurements.

13. The closed-loop volume control system of claim 1 wherein the control system is configured to control the volume by reducing an amplitude of a frequency component of the projected audible signal when the measured sound pressure level corresponding to the frequency component exceeds a threshold.

14. The closed-loop volume control system of claim 1 wherein the control system is co-located with the speaker and the pressure transducer in the audio earphone.

15. The closed-loop volume control system of claim 1 wherein the speaker and the pressure transducer are co-located in the audio earphone, and wherein the control system is located in a remote electronic device connected to the audio earphone via a wired connection.

16. The closed-loop volume control system of claim 1 wherein the speaker and the pressure transducer are co-located in the audio earphone, and wherein the control system is located in a remote electronic device connected to the audio earphone via a wireless connection.

17. The closed-loop volume control system of claim 1 wherein the control system is further configured to cancel noise present in the ear canal based on an inactivity sound pressure level measured by the pressure transducer when the speaker is inactive.

18. The closed-loop volume control system of claim 1 wherein the pressure transducer is acoustically isolated from the audible signal inside the audio earphone, and wherein the pressure transducer is acoustically coupled to the audible signal inside the ear canal.

19. A method of controlling sound pressure levels in an ear canal, the method comprising:
measuring a sound pressure level in the ear canal using a pressure transducer disposed in the ear canal; and
controlling a volume of an audible signal projected into the ear canal by a speaker based on the measured sound pressure level.

20. The method of claim 19 further comprising:
driving an amplifier with an amplifier drive signal; and
driving the speaker with a speaker drive signal output by the amplifier to project the audible signal from the speaker.

21. The method of claim 20 wherein controlling the volume comprises controlling an amplitude of the amplifier drive signal based on the measured sound pressure level.

22. The method of claim 20 wherein controlling the volume comprises controlling a gain of the amplifier.

23. The method of claim 19 wherein controlling the volume comprises reducing the volume of the projected audible signal when the measured sound pressure level exceeds a first threshold.

24. The method of claim 19 wherein controlling the volume comprises reducing the volume of the projected audible signal when the measured sound pressure level exceeds a first threshold for longer than a first time period.

25. The method of claim 24 wherein controlling the volume comprises increasing the volume of the projected audible signal when the measured sound pressure level remains below a second threshold for longer than a second time period.

26. The method of claim 19 wherein controlling the volume comprises reducing the volume of the projected audible signal when the measured sound pressure level exceeds a first threshold for longer than a first time period or when the measured sound pressure level exceeds a second threshold for longer than a second time period.

27. The method of claim 19 further comprising isolating different frequency components of the measured sound pressure level to generate frequency-dependent sound pressure level measurements.

28. The method of claim 27 wherein controlling the volume comprises controlling an amplitude of one or more frequency components of the projected audible signal based on the frequency-dependent sound pressure level measurements.

29. The method of claim 27 further comprising equalizing the projected audible signal based on the frequency-dependent sound pressure level measurements.

30. The method of claim 19 wherein controlling the volume comprises reducing an amplitude of a frequency component of the projected audible signal when the measured sound pressure level corresponding to the frequency component exceeds a threshold.

31. The method of claim 19 further comprising:
generating a noise cancelling signal based on an inactivity sound pressure level measured when the speaker is inactive; and
cancelling noise from the ear canal by projecting the noise cancelling signal into the ear canal via the speaker.

32. An audio earphone comprising:
a pressure transducer configured to measure a sound pressure level in an ear canal; and
a speaker configured to project an audible signal into the ear canal at a volume at least partially controlled based on the measured sound pressure level.

33. The audio earphone of claim 32 further comprising a controller operatively connected to the speaker and the pressure transducer, said controller configured to control the volume of the projected audible signal by controlling an amplitude of the projected audible signal based on the measured sound pressure level.

34. The audio earphone of claim 33 wherein the controller is configured to reduce the amplitude of the projected audible signal when the measured sound pressure level exceeds a first threshold.

35. The audio earphone of claim 33 wherein the controller is configured to reduce the amplitude of the projected audible signal when the measured sound pressure level exceeds a first threshold for longer than a first time period.

36. The audio earphone of claim 35 wherein the controller is configured to increase the amplitude of the projected audible signal when the measured sound pressure level remains below a second threshold for longer than a second time period.

37. The audio earphone of claim 33 wherein the controller is further configured to cancel noise present in the ear canal based on an inactivity sound pressure level measured when the speaker is inactive.

38. The audio earphone of claim 32 wherein the pressure transducer is acoustically isolated from the audible signal in the audio earphone, and wherein the pressure transducer is acoustically coupled to the audible signal in the ear canal.
